(19) United States
(12) Patent Application Publication
(10) Pub. No.: US 2023/0162612 A1
(43) Pub. Date: May 25, 2023

(54) METHOD OF MAKING LECTURES MORE INTERACTIVE WITH REALTIME AND SAVED QUESTIONS AND ANSWERS

(71) Applicant: UNIVERSITY OF SOUTH FLORIDA, Tampa, FL (US)

(72) Inventor: Kyle Brandon REED, Tampa, FL (US)

(21) Appl. No.: 17/919,238

(22) PCT Filed: Nov. 23, 2020
(86) PCT No.: PCT/US2020/061737

§ 371 Date: Oct. 14, 2022

Related U.S. Application Data
(60) Provisional application No. 63/010,969, filed on Apr. 16, 2020.

(51) Int. Cl. G09B 5/06; G09B 5/14; H04N 7/15

(52) U.S. Cl. CPC G09B 5/065; G09B 5/14; H04N 7/152

(57) ABSTRACT

Disclosed are various embodiments of a module publication application, interactive modules, and student user interfaces that make lectures more interactive. An instructor user interface generated by the module publication application captures a video of a lecture. Interactive modules including video segments and segment metadata are generated based on the video. A student user interface can render a presentation of the video segments and an interactive region showing questions that are related to the presentation. The questions shown in the interactive region can be updated based on a current timecode of the presentation.

### CROSS-REFERENCE TO RELATED APPLICATIONS

This application claims the benefit of and priority to U.S. Provisional Pat.Application No. 63/010,969 entitled “Method of Making Lectures More Interactive With Real-Time and Saved Questions and Answers” filed on Apr. 16, 2020, which is expressly incorporated by reference as if fully set forth herein in its entirety.

### BACKGROUND

Lecture videos can be one sided with instructors giving information and students trying to absorb information that may or may not be relevant to them. For example, one student may want multiple examples but another student may only need one example. In many ways, existing technology may be unsuitable for delivering lecture videos to students in this customized way. In a typical presentation of a recorded video, all students may see the same content. Students can skip ahead, but they will not know for sure what they missed. In some cases, a lack of appropriate technology may result in students being unable to find relevant information associated with lecture videos.

### SUMMARY

Disclosed herein are various systems and computer-implemented methods of making lectures more interactive. In various aspects, the present systems and methods can include generating, by a computing device, an instructor user interface configured to capture a video of a lecture. The computing device can obtain the video of the lecture and generate an interactive module including a plurality of segments and segment metadata. The computing device can determine that an identifier of at least one of a chat request or a potential question is in a queue. The computing device can obtain answer data comprising a video stream or a recorded video associated with the at least one of the chat request or the potential question. The computing device can publish the answer data as an answer for at least one of the plurality of segments, and associate the answer with the at least one of the plurality of segments, at least one of a plurality of questions, and the segment metadata.

According to another example, a computing device can obtain an interactive module comprising a video segments and segment metadata. The segments can be associated with a video of a lecture. The computing device can obtain a first plurality of questions that are stored in a data store and associated with the interactive module. The computing device can generate a student user interface including a timeline and a presentation region for a presentation of the video segments on a display of a client device.

The student user interface can include an interactive region for a user of the client device to interact with questions and answers in association with the timeline, The student user interface can be configured to render, in the interactive region, a preview text of at least one of the first plurality of questions for a predetermined amount of time after the presentation reaches a timecode associated with the first plurality of questions.

The student user interface can include a selectable user interface element configured to obtain, from the client device, user input data including a second plurality of questions. If an instructor user is available via an instructor user interface, answer data comprising a real-time video stream associated with the second plurality of questions can be captured. The computing device can publish a preview text associated with the at least one of the second plurality of questions, and publish the answer data for the interactive module.

The systems and methods can include rendering, by a computing device, a presentation of a video segments of an interactive module. The computing device can render an interactive region comprising a preview text of at least one of a first plurality of questions associated with video segments. The computing device can render, in the interactive region, a show answer user interface element configured to generate a network page for streaming a real-time video stream or rendering a recorded video of an answer to the at least one of the first plurality of questions. In an instance in which the show answer user interface element is selected, the computing device can pause the presentation of the video segments and generate the network page for streaming the real-time video stream or rendering the recorded video of the answer.

Other systems, methods, features, and advantages of the present disclosure for making lectures more interactive will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a drawing of a networked environment according to various embodiments of the present disclosure.

FIGS. 2A and 2B are pictorial diagrams of example user interfaces rendered by a client device in the networked environment of FIG. 1 according to various embodiments of the present disclosure.

FIGS. 3A and 3B are flowcharts illustrating examples of functionality implemented in a computing environment of the networked environment of FIG. 1 according to various embodiments of the present disclosure.

FIG. 4 is a flowchart illustrating examples of functionality implemented in a student client device of the networked environment of FIG. 1 according to various embodiments of the present disclosure.

FIG. 5 is a schematic block diagram that provides one example illustration of a computing environment employed in the networked environment of FIG. 1 according to various embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions or positionings may be exaggerated to help visually convey certain principles. In the drawings, similar reference numerals between figures designate like or corresponding, but not necessarily the same, elements.

### DETAILED DESCRIPTION

Described below are various embodiments of a system and computer-implemented method of making lectures more interactive. Typically, instructional videos can be one sided with hosts or instructors giving information and students trying to absorb the information that may or may not be relevant to them. For example, one student may want multiple examples but another student may only need one. In a typical linear video, all students will see the same content. They can try to skip ahead, but they won’t know for sure what they missed.

Various embodiments of the present disclosure introduce approaches for generating interactive modules which can include segments made up of videos or other content about a particular topic or subject. The interactive modules can be presented via a user interface that allows a student or other user to watch the videos, to see questions that other users have asked, and to ask questions. Some aspects involve capturing, from an instructor client device, a real-time video stream of answers to the questions. In some embodiments, the user interacts with the user interface to view the answers to the questions.

For example, the user interface can include a timeline that shows progress through a presentation of the interactive module or its segments. The timeline can show an indication of questions or answers which are relevant to the presentation. In some examples, students can see a question appear with an option to pause the presentation and go watch the answer to that question. This gives students the opportunity to see the questions and answers that other students have asked during the video. In the following discussion, a general description of a computer-implemented method and its components is provided, followed by a discussion of the operation of the same.

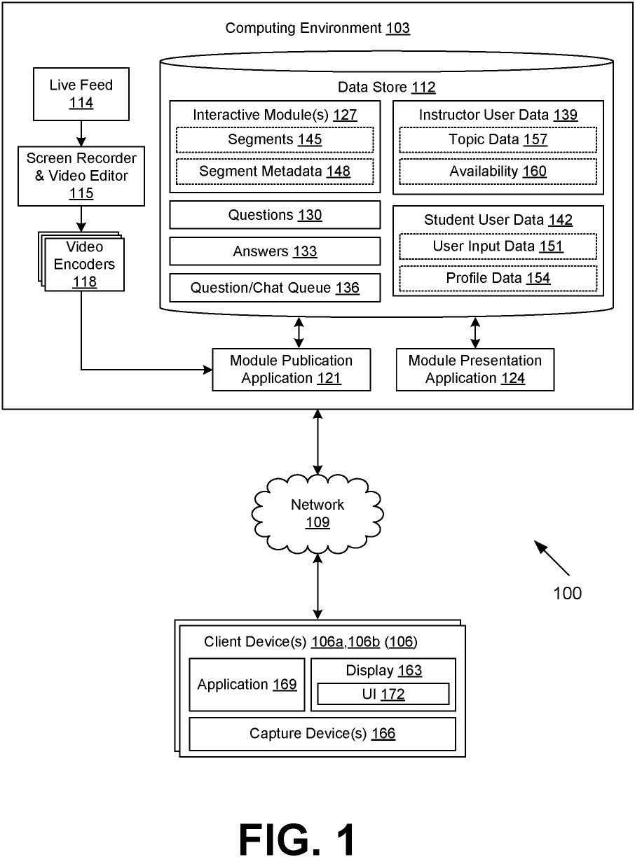

Referring now to FIG. 1, shown is a networked environment 100 according to various embodiments. The networked environment 100 includes a computing environment 103, and one or more client devices 106 (e.g., an instructor client device 106a and/or a student client device 106b) which are in data communication with each other via a network 109. The network 109 includes, for example, the internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 may comprise, for example, a server computer or any other system providing computing capability. Alternatively, the computing environment 103 may employ a plurality of computing devices that may be arranged, for example, in one or more server banks, computer banks, or other arrangements. Such computing devices may be located in a single installation or may be distributed among many different geographical locations. For example, the computing environment 103 may include a plurality of computing devices that together may comprise a hosted computing resource, a grid computing resource and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103 include, for example, a screen recorder and video editor 115, a plurality of video encoders 118, a module publication application 121, a module presentation application 124, and other applications, services, processes, systems, engines, or functionality not discussed herein. The data stored in the data store 112 includes, for example, interactive module(s) 127, questions 130, answers 133, a question/chat queue 136, instructor user data 139, student user data 142, and potentially other data.

The screen recorder and video editor 115 obtains a live feed 114, e.g., a live feed from the instructor client device 106a which shows an instructor user giving a lecture or answering a question associated with a particular topic of interest. The screen recorder and video editor 115 can be executed to process the live feed 114 and provide the live feed 114 to the plurality of video encoders 118. The live feed 114 may be in an uncompressed or compressed format. The screen recorder and video editor 115 can overlay or combine the live feed 114 with a screen buffer or recording from a display of one of the client devices 106 to provide an explanatory video or video feed.

The video encoders 118 can compress the video feed using one or more codecs (e.g., Moving Pictures Experts Group (MPEG)-2, MPEG-4, High Efficiency Video Coding (HEVC), and/or other formats) in order to reduce the bitrate of the video feed for multiple quality levels. The video encoders 118 may generate multiple versions of a video stream (e.g., 8K, 4K, 1024p, 480i, etc.) that can be received by client devices 106 having differing available network bandwidths.

The screen recorder and video editor 115 allows an instructor user to generate edits or annotations based on the video stream, a recorded video, or the screen buffer. In one example, the edits or annotations generated by the screen recorder and video editor 115 allow a student user to view a recorded video while the edits or annotations provided by the instructor user are shown in real-time overlaid onto the recorded view.

The module publication application 121 can be executed to generate an interactive module 127 based on the video feed or the video stream obtained from the video encoders 118. The module publication application 121 allows the interactive module 127 to be updated based on the questions 130 or the answers 133. The questions 130 can include text of questions, timecodes associated with a presentation (e.g., when the questions were asked during a presentation, or a timecode that has been modified following the questions being ask), and other data about questions associated with a presentation of the interactive module 127. The answers 133 can include data about answers obtained or captured from an instructor client device 106a. The questions 130 and the answers 133 can correspond to one-to-one question-answer pairs, e.g., when one of the answers 133 is an answer to a particular one of the questions 130. In some other examples, questions 130 and the answers 133 can have a one-to-many relationship, many-to-one relationship, many-to-many relationship, or other relationship. For example, many of the questions 130 can correspond to one of the answers 133.

The module presentation application 124 can be executed to provide the interactive modules 127, the questions 130, and the answers 133 to students, conference attendees, or other users of the client devices 106. The module presentation application 124 can generate a user interface for a presentation of the interactive module 127 (or segments 145 of the interactive module 127) on a display of the student client device 106b.

The user interface generated by the module presentation application 124 allows users to see questions that have been asked. While watching the segments 145, questions 130 (e.g., questions that have associated answers 133 or extra videos that the instructor user has added) can be available to the student users to watch. For example, the questions can include a first plurality of questions 130 which have been stored in the data store 112. The user interface can be configured to show individual ones of the first plurality of questions 130 when they are relevant to the presentation of the interactive module 127.

The user interface allows users to ask questions at any point during the interactive modules 127. The user interface can be configured to obtain, from the student client device 106b, data comprising a potential question to be considered as one of the questions 130 for the interactive module 127. The module presentation application 124 can process the data and store the processed data as user input data 151. The potential question can include text, an audio and/or video recording, a document with a written out question, or other suitable data for inputting the potential question. The module presentation application 124 can generate at least one of a second plurality of questions 130 based on the user input data 151, and store the second plurality of questions 130 in the data store 112. The module presentation application 124 allows questions 130 and the answers 133 to be rated, e.g., the student user can rate a question 130 or an answer 133 from 1 to 5 stars, with 5 being the highest rating.

An interactive module 127 can include a plurality of video segments or other segments 145, and segment metadata 148. The segments 145 can be presented to client devices 106 over the network 109. The interactive module 127 can comprise data employed to allow a user to interact with the questions 130 and the answers 133 in real-time during a presentation of the segments 145. The segments 145 correspond to individual ones of the video segments or other segments 145 that are served to the client devices 106. Multiple versions of a segment 145 can be encoded using different bitrates or codecs.

The segment metadata 148 corresponds to data about the segments 145, e.g., data describing duration, associated course or topic, difficulty level, and other data including data that can associate the segments 145 with particular questions 130 or answers 133. The segment metadata 148 can be created when the interactive module 127 is generated or in real-time while the interactive module 127 is updated.

The student user data 142 comprises, for example, the user input data 151, profile data 154, and potentially other data. According to various embodiments, the user input data 151 can be received in real-time from the client device 106, for example, by a user interacting with components of a user interface. For example, the user can input data via the user interface utilizing a keyboard, a mouse click, a body gesture, and/or a voice command. The input data can be received by the module presentation application 124 in near real-time.

The profile data 154 can comprise, for example, information related to the student user, such as an email address, password, passcode, or other means of identification and/or authentication. For example, the profile data 154 of a student named “John Doe” can indicate that John Doe’s email address is “jdoe123@university.edu.” In some aspects, the profile data 154 can be stored to allow the computing environment 103 to notify a student user who has submitted one of the questions 130 about a related answer 133 that is available.

The instructor user data 139, comprises, for example, topic data 157, availability 160 of the instructor user, and potentially other data. The topic data 157 can include data about a particular course or topic presented by the instructor user. The availability 160 can include times during the week that an instructor user is available for providing answers to questions (e.g., via a video conference or a recorded video). The availability 160 can also be a flag indicating that an instructor user is currently live and logged into the system awaiting questions, currently unavailable, currently conducting a conference with a student user, etc. The instructor user data 139 can also include data that allows an instructor user to be notified about activity within the computing environment 103 such as questions or chat requests.

The client devices 106 can include, for example, a processor-based system such as a computer system. Such a computer system can be embodied in the form of a desktop computer, a laptop computer, personal digital assistants, cellular telephones, smartphones, set-top boxes, smart televisions, music players, web pads, tablet computer systems, game consoles, electronic book readers, or other devices with like capability.

The client devices 106 can include a respective display 163. The displays 163 can comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc. The client devices 106 can also include one or more capture devices 166 such as image cameras, video cameras, microphones, three-dimensional video capture devices, and other capture devices.

The client devices 106 can be configured to execute various applications such as the application 169 and/or other applications. The application 169 can be executed in a client device 106, for example, to access network content served up by the computing environment 103 and/or other servers, thereby rendering a user interface 172 on the display 163. To this end, the application 169 can comprise, for example, a browser, a dedicated application, etc., and the user interface 172 can comprise a content page, an application screen, etc. The client device 106 can be configured to execute applications beyond the application 169 such as, for example, learning management applications, email applications, word processors, presentation applications, drawing or annotation applications, spreadsheets, and/or other applications.

Next, a general description of the operation of the various components of the networked environment 100 is provided. To begin, an instructor user launches the application 169 and accesses the module publication application 121. Various instructor user interfaces can be sent to the instructor client device 106a for client-side execution. An instructor user interface can be configured to cause the module publication application 121 to store one or more segments 145 comprising videos encoded by the video encoders 118 (or videos captured by the capture device(s) 166 and sent by the instructor client device 106a) and to generate or publish the segments 145 as the interactive module 127. The module publication application 121 can generate segment metadata 148 associated with the segments 145.

A student user launches the application 169 on the student client device 106b and accesses the module presentation application 124. The module presentation application 124 obtains the interactive module 127 comprising the segments 145 and the segment metadata 148. The module presentation application 124 can determine, based on the segment metadata 148, that a first plurality of the questions 130 are associated with the interactive module 127 or individual ones of the segments 145. The module presentation application 124 can obtain the first plurality of the questions 130 from the data store 112.

Various student user interfaces can be sent to the student client device 106b for client-side execution. The module presentation application 124 can generate a student user interface that includes a presentation region for a presentation of the segments 145 on the display 163 of the student client device 106b. The student user interface can present the first plurality of the questions 130 at a time when they are relevant to the presentation, such as when indicated by a timecode within the segment metadata 148. The questions 130 and/or the answers 133 can include a hash or other data associating the questions 130 and/or the answers 133 with one or more timecodes of the segments 145.

In some aspects, the module presentation application 124 can gather metrics to be used as at least part of a machine learning module or as input to an adaptive learning system. For example, the module presentation application 124 can be employed to determine metrics from the user input data 151 or interactions of the student user with the student user interface. Metrics can, for example, compare an answer from a student user associated with one set of the topic data 157 taught by a particular instructor user with another student user associated with another set of the topic data 157. In a simple example, it can be determined that student users who are associated with undergraduate topic data 157 can benefit from access to questions 130 and/or answers 133 presenting additional topics, whereas student users who are associated with graduate topic data 157 may not. A machine learning algorithm can mine the metrics gathered or determined by the module presentation application 124 to ascertain topics to present to particular student users. In this way, the module presentation application 124 can present a dynamic lecture configured to meet the needs of particular student users. In other aspects, the module publication application 121 can create points that allow the module presentation application 124 to dynamically break out topics into segments 145 having further detail where questions are arising. For example, the instructor user may see that one of the segments 145 needs work, perhaps because student users ask many questions or face difficulty learning about a particular topic. The module publication application 121 can divide the topic into two or more segments 145 about the topic (or a sub-topic), which each incorporate answers to questions, and further detail about the topic or sub-topic.

Aspects of the computing environment 103 can be used to gather metrics to help understand gaps in knowledge of the student users. These aspects can allow an instructor user to refine one of the interactive modules 127, e.g., by incorporating more questions, more answers, more segments 145, by dividing a segment 145 into more detailed segments 145, etc. Metrics can determine what questions are being asked by student users and how the student users are interacting with the module presentation application 124.

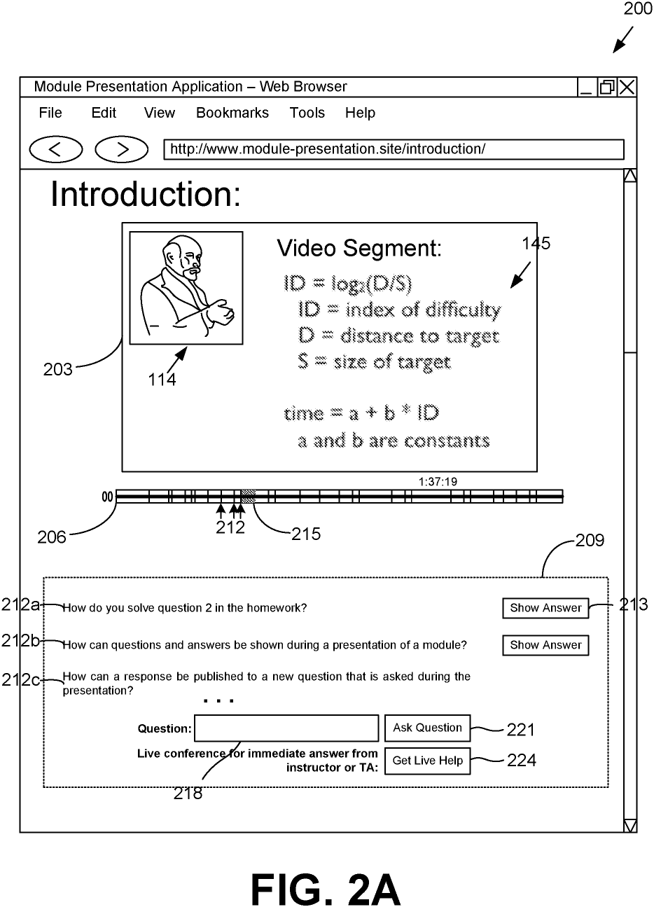

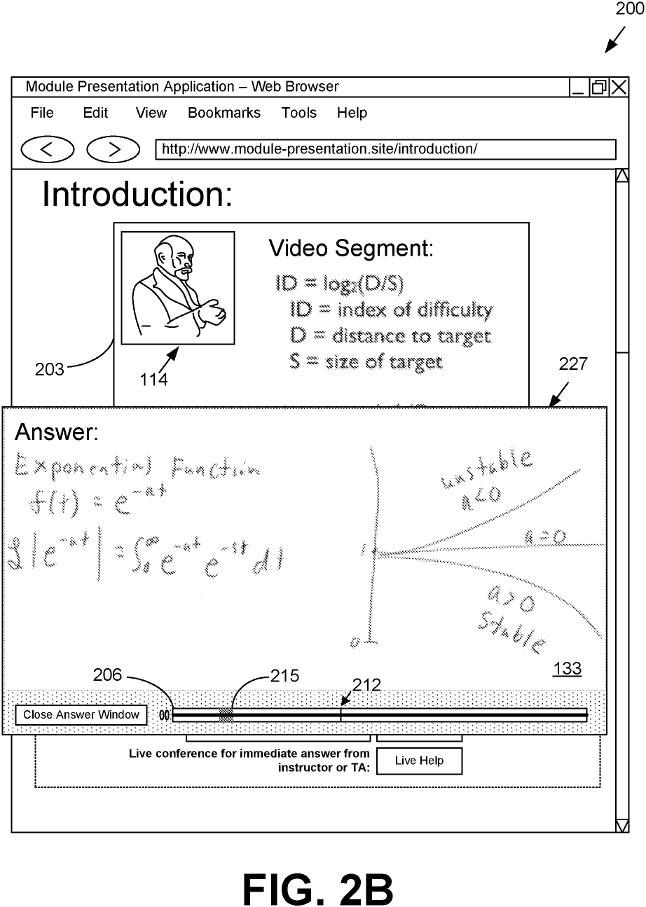

Turning now to FIG. 2A, shown is a pictorial diagram of an example user interface 200 rendered according to various embodiments of the present disclosure. The user interface 200 corresponds to a student user interface generated by the module presentation application 124 and rendered by the student client device 106b in the networked environment 100 of FIG. 1.

FIG. 2A shows an example of how a student user can interact with a lecture or other content. The student user can ask a question related to the content. They can interact with the user interface 200, e.g., to get an immediate help from a teaching assistant or instructor, or to ask a question and be notified when an answer is available.

The user interface 200 includes a presentation region 203, a timeline 206, and an interactive region 209. The user interface 200 can render a lecture video in the presentation region 203. The timeline 206 or the interactive region 209 can also be rendered (e.g., below the video). The presentation region 203 allows one or more of the segments 145 to be presented or rendered as content on a student client device 106b (FIG. 1). The segments 145 can encode a video stream or a screen buffer from the instructor client device 106a. The presentation region 203 of FIG. 2A shows that a live feed 114 has been overlaid with the video stream or the screen buffer. Although not depicted, the user interface 200 can include one or more user interface elements that decrease, increase, or otherwise alter a playback speed for the segments 145.

The timeline 206 shows indications 212 of questions and/or answers which are relevant to the presentation of the segments 145. The example timeline 206 shown in FIG. 2A has several of the indications 212, three of which are highlighted by arrows. The timeline 206 shows a current position 215 for the presentation. Below the timeline 206, the user interface 200 includes an interactive region 209 for a user to interact with questions and answers which can be associated with the timeline 206.

Although the indications 212 are shown in FIG. 2A as vertical bars along the timeline 206, any suitable format can be used for indicating particular ones of the questions 130 or the answers 133. For example, the indications can be dots or other indications shown in association with the timeline 206.

The user interface 200 can be configured to render content about one or more of the questions 130 or the answers 133 (FIG. 1) in the interactive region 209. The interactive region 209 can also include an input field 218 and a selectable user interface element 221. Content can be rendered for example according to a relevancy based on comparing the segment metadata 148 (or topic data 157) to the profile data 154 of the student user data 142. In other aspects, content can be rendered for a predetermined amount of time (e.g., 30 second). The content can be highlighted or otherwise emphasized to show content that has been added, such as for any of the questions 130 or the answers 133 (FIG. 1) which have become relevant to the presentation of the segments 145. In some aspects, content that is no longer relevant is removed from the user interface 200 and other content can scroll, slide, or move up within the interactive region 209, or be added to the interactive region 209. If multiple questions are located near one another in the video, they can be stacked so questions appear and the older ones fade out as the relevance to the current portion of the video decreases.

There are many ways that relevancy of the questions 130 and/or the answers 133 can be determined. In some examples, the module presentation application 124 can configure the user interface 200 to render the content about the questions 130 in an instance in which the questions 130 were submitted by a student at a time that corresponds to the current position 215 indicated in the timeline 206. The user interface 200 can also be configured to cause any content that has been rendered to be removed from the interactive region 209.

The computing environment 103 can also provide moderation of questions 130. Based on data stored in the questions 130, some questions can be public questions that some (or all) users have access to, e.g., over multiple years of topics or classes being taught. Other questions 130 can be questions that are only relevant to a particular class, e.g., “Is the test next week?,” or “Can we have an extension on this assignment?” There can even be some questions 130 that are only relevant to a particular one of the student users. Aspects of the module publication application 121 can allow an instructor user to moderate the questions 130 and for example store one of the questions 130 associated with data that allows the question 130 to be rendered only to the particular student. Some other examples provide tags for the questions 130 so that the questions can be broken up by topic, e.g., “Fitt’s Law,” “logarithmic functions,” “the concept of derivative,” or “how to find the derivative of a function.” The module publication application 121 can allow questions 130 to be tagged with a difficulty. For example segments 145 associated with the topic of “the concept of derivative” can be tagged with one level or a low level of difficulty while segments 145 associated with the topic of “how to find the derivative of a function” can be tagged with a second level or a high level of difficulty. The module presentation application 124 can present segments 145 for the topic of “the concept of derivative” to high-school student users and present segments 145 for the topic of “the concept of derivative” along with segments 145 for the topic of “how to find the derivative of a function” to undergraduate or other users who need to know how to find the derivative of a function.

In many aspects, various users of the computing environment 103 can provide answers 133 to questions 130. For example, different topics can be answered by different users, with a teaching assistant responding for certain topics, and a professor responding for other topics. Or, the questions can be answered by various users according to the level of difficulty of the respective questions. Another example provides that one student user can answer a question 130 for another student user.

The module publication application 121 can allow the instructor user to modify a timecode for the questions 130. For example, one of the questions 130 can have been submitted at a particular time associated with one of the segments 145, but it is desirable for the question 130 to appear at a different point, e.g., earlier or later in the segments 145. The module presentation application 124 can determine, based on the modified timecode, to render content for the question 130 in the interactive region 209 at a time corresponding to the modified timecode.

The questions 130 (FIG. 1) and associated answers 133 (FIG. 1) can be updated by the instructor user at any point and can be presented to the student users immediately. The newly added videos can be added in real-time so that student user that are watching behind where the new answer 133 is located are given the chance to see the newly added questions 130 and answers 133 (FIG. 1). The videos of the segments 145 (FIG. 1) can be available for later classes to see.

Continuing with the example of FIG. 2A, the user interface 200 has rendered the segments 145 (FIG. 1), and the current position 215 has advanced along the timeline 206 to reach its current point. The module presentation application 124 can use the segment metadata 148 to determine that the current position 215 corresponds to a time when one or more of the questions 130 was submitted, and render content for the question 130 in the interactive region 209.

FIG. 2A shows that preview text 212a ... 212c has been rendered in the interactive region 209 for the questions 130 associated with the indications 212. The preview text 212a can state the question 130 asked and stay up long enough for the student user to decide whether to watch the video of the associated answer 133. Preview text can include at least a portion of the questions 130, such as “How do you solve question 2 in the homework?,” “How can questions and answers be shown during a presentation of a module?,” and “How can a response be published to a new question that is asked during the presentation of a module?” as is respectively shown by the preview text 212a ... 212c.

The preview text 212a corresponding to one of the questions 130 has been rendered in a first position of the interactive region 209 because its corresponding question 130 is associated with being submitted at a particular timecode that occurs earlier with respect to the current position 215 and other ones of the questions 130. The mark above the first indication 212 indicates the particular timecode for the corresponding question 130 along the timeline 206 according to timecode data about the question 130. The preview text 212b can be shown in a second position of the interactive region 209 because a timecode of its corresponding question 130 occurs as indicated by the second arrow, and so forth.

The user interface 200 includes a show answer user interface element 213 that is configured to generate a network page for streaming or rendering an answer 133 to the question 130. The answer 133 can comprise, for example, a real-time video stream or a recorded video of the instructor user answering the question 130. The show answer user interface element 213 can also be configured to pause the presentation of at least one of the segments 145 in the user interface 200. In this way, the student user selects the show answer user interface element 213 to watch the answer 133, the lecture video can pause and an overlaid video can appear that plays the answer 133 to the question 130. At any point, the student can close that window and continue with the lecture.

The user interface 200 can be configured to generate a network page for streaming or rendering an answer 133 to the question 130 in other ways. For example, the questions 130 or the answers 133 can be associated dots (or other indications) that appear below the timeline 206, indications that appear in some other relation to the timeline 206, indications that appear in some relation to the presentation of the segments 145, or other suitable ways for indicating that the questions 130 or the answers 133 are available. The dots or other indications can be configured such that when the student user interacts with one of the indications, its answer 133 can be rendered or streamed.

The user interface 200 can also include the input field 218, and a selectable user interface element 221 that is configured to obtain data from the input field 218 and, when selected, to send the data to the computing environment 103 to be stored as the user input data 151 (FIG. 1). The input field 218 allows the student user to enter text, an audio and/or video recording, a document with a written out question, or other suitable data for a potential question to be considered for at least one of a second plurality of questions 130. The user interface 200 can send the data from the input field 218 to the computing environment 103 along with an email address or other data to be stored as profile data 154 for the student user who input the data to the input field 218. In an instance in which the user input data 151 is obtained, the computing environment 103 can determine an availability of an instructor user to answer at least one of the second plurality of questions 130. In some aspects, the input field 218 can be provided with an equation editor that is configured to typeset or accept written equations (e.g., in a LaTeX or other format)

If the instructor user is not available, the potential question can be placed in the question/chat queue 136 for the instructor user to answer later. In an instance in which it is determined that the instructor user is unavailable, the module publication application 121 can generate a notification comprising a submission element configured to capture answer data comprising a recorded video. If the instructor user is available, the instructor user can have a live video chat about the question 130. The module publication application 121, the module presentation application 124, the application 169, and/or other applications in the networked environment 100 can be executed to provide and stream video and audio to users in a video conference using one or more client devices 106. The user interface 200 can obtain a request, via the live help 224, from a student user to initiate a video consultation with an instructor user. The user interface 200 can be configured to toggle the live help 224 on or off depending on the availability 160 of the instructor, a teaching assistant, or other instructor user.

Videos can be recorded and made available by the computing environment 103 as the segments 145 (or the answers 133) to any point of the timeline 206. The segments 145, which can be videos of the instructor user answering the questions, can be kept so that future classes have the option to see previous student’s questions and the related answers. The instructor user can optionally associate a clarifying video at any point in the segment 145 if the instructor user desires to provide additional examples or alternate explanations for those that might not understand certain points. Any of the segments 145 can be removed, unassociated, or deleted at any point. The instructor user can also chose to not make a video available to others at the end of the chat.

According to days and/or times specified in the availability 160, the instructor user can be available to answer questions related to the segment 145 at whichever current position 215 the student user is at. This can include the student writing out his potential question and/or giving a voice description via the input field 218.

The module publication application 121 can generate an instructor user interface that displays the potential question along with an indication of the current position 215 in the video segments 145 to provide the instructor user with context regarding the potential question. The instructor user interface provides an option to render the video segments 145 at the current position 215 or at an earlier position compared to the current position 215 (e.g., to back up slightly in the video segments 145).

The instructor user interface allows the instructor user to turn on a live feed 114 and start answering the question or record themselves answering the question or upload a document with a written out solution. If the feed is live, it can behave much like in a class where the student and instructor user can interact in real-time. If a video was recorded, the recorded video can be published by the module publication application 121 for the student user to watch and then continue on with the lecture. If the instructor user is unavailable at that moment, an identifier for the student user and/or the potential question can be placed in the question/chat queue 136 with the option to wait for the instructor user or to continue on with the video and get notified when the instructor user is available. If two student users are online and their respective identifiers are in the question/chat queue 136 at a similar place in the video segments 145, the student users can be given an option to chat while they are waiting. If their questions are related, they can be given the choice to join together for the answer. If the student is no longer available when the instructor user is available, the instructor user can still answer the question and post the question as a question 130 for one or more student users to see.

The user interface 200 can include the questions 130 and answers 133 that are associated with topic data 157 from previous years. The instructor user can also write questions to be stored as the questions 130 and add answers to be stored as the answers 133 at any point, which could be used for additional practice for students that want it.

In an instance in which it is determined that the instructor user is unavailable via the live help 224, or the student user submits a potential question via the selectable user interface element 221, the computing environment 103 can generate a notification message comprising a submission element configured to capture answer data comprising a recorded video of the instructor user answering the question. When the question is answered, the computing environment 103 can notify the student user that the answer 133 is available, and the user interface 200 can be updated accordingly. Students currently watching the rendered content of the segments 145 have the option to watch the related answer 133.

If the student requests, via the live help 224, to discuss directly with the instructor user a video chat can be initiated. The video chat could be face to face or could be displaying a whiteboard or a virtual paper (e.g., writing on an iPad or tablet) where the answer can be written out and displayed to the student user. In this form, the student user and instructor user can discuss the solution with follow-up questions. This video can be recorded and tagged at the point where the student user asked the question so other student users can be able to watch the answer to the question. When this call appears to the instructor user via the instructor user interface, the student user can appear along with their written out question and a second video can start playing a little bit before the time when the student user asked the question to give the instructor user an idea about where in the lecture this question is coming up at.

The user interface 200 can give student users an option to opt out if they do not want their live discussions with the instructor user to be kept and available for others to see. In some examples, the option could include allowing the current class to see them (but not future classes), or for no one to see the videos. Videos recorded without the student user being available for discussion can omit this option from the student user since the student user does not have any personally-identifiable information (e.g., name, voice, or face) in the video for the answer 133.

Another aspect of this disclosure includes presenting questions 130 that can require an answer to continue. For example, the instructor user could put a problem in the questions 130 or the segments 145 and have the student users solve it on their own. A response would be required from a student user and answers from respective student users would be logged so the instructor user can check on progress of the student users. If the student user gets the correct answer, he or she can have an option to continue with the segments 145 or to watch an answer 133 that is the worked out solution. If the answer from the student user is incorrect, the student user can have to watch the solution video before continuing on with the lecture video.

Referring next to FIG. 2B, shown is a pictorial diagram of an example user interface 200 rendered according to various embodiments of the present disclosure. FIG. 2B shows an example of the user interface 200 generated after the student user has selected the show answer user interface element 213 (FIG. 2A). The user interface 200 has caused a window 227 to be rendered showing an answer 133 (FIG. 1) corresponding to the preview text 212a (FIG. 2A) of the question 130 (FIG. 1).

FIG. 2B shows that when the student user clicks on the show answer user interface element 213 (FIG. 2A) to show the answer, the window 227 renders a video for an answer 133 (FIG. 1). The timeline 206 of FIG. 2B shows an indication 212 of a question 130 (FIG. 1) which is relevant to the presentation of the answer 133 (FIG. 1). The ability for a student user to ask questions can be iterative, so a student user can ask a follow-up question to a video that is answering another student’s question.

Those student users who watch first may not have the benefit of the questions 130 and answers 133 from other students, so student users can have an option to be notified of any new questions 130 or answers 133. The student users can sign up to be notified of new questions 130 and answers 133, or be notified of all new questions 130 and answers 133 that are posted after the time they watched the video.

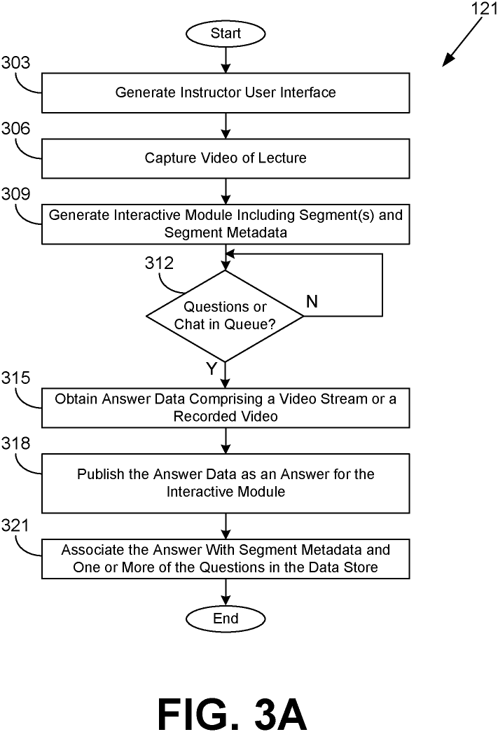

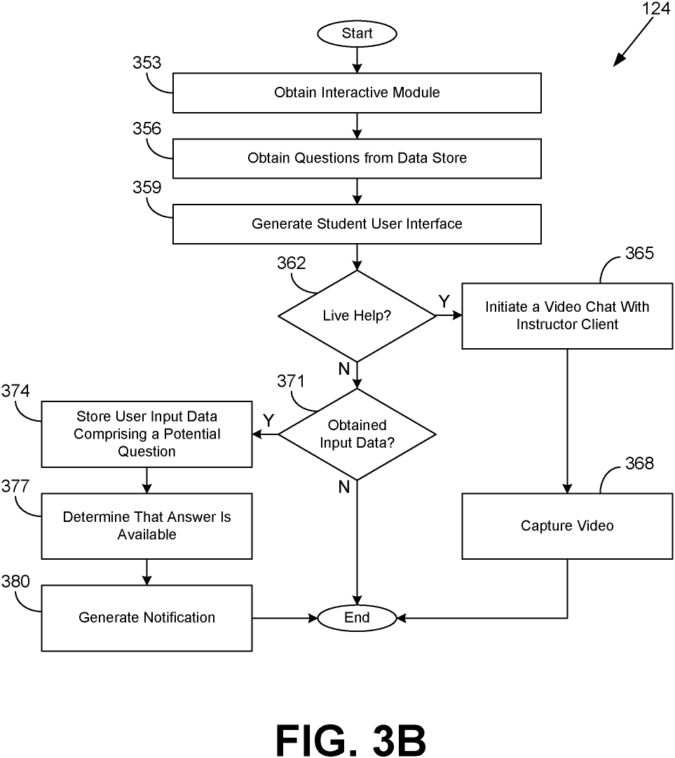

Referring next to FIG. 3A, shown is a flowchart that provides one example of the operation of a portion of the module publication application 121 (FIG. 1) according to various embodiments. Portions of the flowchart of FIG. 3A can be performed by the application 169 (FIG. 1) in communication with the module publication application 121 (FIG. 1) and the screen recording and video editor 115 in some embodiments. It is understood that the flowchart of FIG. 3A provides merely an example of the many different types of functional arrangements that can be employed to implement the operation of the portion of the module publication application 121 as described herein. As an alternative, the flowchart of FIG. 3A can be viewed as depicting an example of elements of a method implemented in the computing environment 103 (FIG. 1) according to one or more embodiments.

Beginning with box 303, the module publication application 121 (FIG. 1) generates an instructor user interface. The instructor user interface can be configured to capture a video feed 114 (FIG. 1) of a lecture. In box 306, the module publication application 121 (FIG. 1) receives the video feed 114 (FIG. 1).

In box 309, the module publication application 121 (FIG. 1) generates an interactive module 127 (FIG. 1) based at least in part on the video feed 114 (FIG. 1). For example, the screen recorder and video editor 115 (FIG. 1) can be executed to generate a plurality of video segments 145. The module publication application 121 (FIG. 1) can publish the plurality of video segments 145 (FIG. 1), and generate segment metadata 148 (FIG. 1) associated with the plurality of video segments 145 (FIG. 1).

In box 312, the module publication application 121 (FIG. 1) determines whether there are identifiers in the question/chat queue 136 (FIG. 1). For example, the identifiers can identify potential questions to be answered or video chat requests. If it is determined there is at least one of a chat request or a potential question associated with the question/chat queue 136 (FIG. 1), the process can proceed to box 315.

In box 315, the module publication application 121 (FIG. 1) obtains answer data comprising a video stream or a recorded video associated with the at least one of the chat request or the potential question. In box 318, the module publication application 121 (FIG. 1) publishes the answer data as an answer 133 (FIG. 1) for at least one of the plurality of segments 145 (FIG. 1). In box 321, the module publication application 121 (FIG. 1) associates the answer 133 (FIG. 1) with the at least one of the plurality of segments 145 (FIG. 1), at least one of a plurality of questions 130 (FIG. 1), and the segment metadata 148 (FIG. 1). Thereafter, the process can proceed to completion.

Although the flowchart of FIG. 3A shows a specific order of execution, it is understood that the order of execution may differ from that which is depicted. For example, portions shown in box 309 and box 312 can be performed during a lecture (e.g., step 306). The module publication application 121 can use speech recognition to determine that the instructor user has spoken a keyword or phrase that starts a question and/or an answer, or a keyword or phrase that ends the question and/or the answer. Alternatively, or in addition, the instructor user can interact with a user interface element in the instructor user interface to indicate a start or an end to a question or an answer. The module publication application 121 can associate a segment of the video feed 114 (FIG. 1) as the question 130 (FIG. 1) or the answer 133 (FIG. 1) (e.g., step 315, step 318, and/or step 321).

In some examples, the tagging of a question and/or an answer in a segment of the video feed 114 (FIG. 1) can be initiated by an instructor user interacting with a user interface element in the instructor user interface. In some other examples, the tagging can be performed by speech recognition functionality in the module publication application 121 that can identify keywords in the video feed 114 (FIG. 1) that indicate a question and/or answer in a segment of the video feed 114 (FIG. 1). Once tagged, the module publication application 121 can remove the question and/or the answer from one of the segments 145 (FIG. 1) associated with the segment of the video feed 114 (FIG. 1). The module publication application 121 can associate the one of the segments 145 (FIG. 1) as the question 130 (FIG. 1) or the answer 133 (FIG. 1).

Turning to FIG. 3B, shown is a flowchart that provides one example of the operation of a portion of the module presentation application 124 (FIG. 1) according to various embodiments. Portions of the flowchart of FIG. 3B can be performed by the application 169 (FIG. 1) in communication with the module presentation application 124 (FIG. 1). It is understood that the flowchart of FIG. 3B provides merely an example of the many different types of functional arrangements that can be employed to implement the operation of the portion of the module presentation application 124 as described herein. As an alternative, the flowchart of FIG. 3B can be viewed as depicting an example of elements of a method implemented in the computing environment 103 (FIG. 1) according to one or more embodiments.

Beginning with box 353, the module presentation application 124 (FIG. 1) obtains an interactive module 127 (FIG. 1). The interactive module 127 (FIG. 1) can include a plurality of video segments 145 (FIG. 1) and segment metadata 148 (FIG. 1).

In box 356, the module presentation application 124 (FIG. 1) obtains a first plurality of questions 130 (FIG. 1) from the data store 112 (FIG. 1). The first plurality of questions 130 (FIG. 1) can be associated with the interactive module 127 (FIG. 1) or one or more of the plurality of video segments 145.

In box 359, the module presentation application 124 (FIG. 1) can generate a student user interface 200 (FIG. 2A). Some examples of the student user interface 200 (FIG. 2A) include a timeline 206 (FIG. 2A), a presentation region 203 (FIG. 2A) for a presentation of the plurality of video segments 145 (FIG. 1) on a display 163 (FIG. 1) of a client device 106 (FIG. 1), or an interactive region 209 (FIG. 2A) for a user of the client device 106 (FIG. 1) to interact with questions 130 (FIG. 1) and answers 133 (FIG. 1). Some examples of the student user interface 200 (FIG. 2A) include a selectable user interface element 221 (FIG. 2A) configured to obtain, from the client device 106 (FIG. 1), user input data 151 (FIG. 1) comprising at least a portion of at least one of a second plurality of questions 130 (FIG. 1).

In box 362, the module presentation application 124 (FIG. 1) determines if a request for live help has been received. For example, the student user interface 200 (FIG. 2A) can obtain a request via the live help 224 (FIG. 2A). If the request is received, the process can continue to box 365. Otherwise, the process can continue to box 371.

In box 365, the module presentation application 124 (FIG. 1) causes a video chat to be initiated with an instructor client device 106a (FIG. 1). In box 368, the module presentation application 124 (FIG. 1) captures video from the video chat performed at box 365.

In box 371, the module presentation application 124 (FIG. 1) determines if user input data 151 (FIG. 1) comprising a potential question has been obtained. In an instance in which the user input data 151 (FIG. 1) is obtained, the process proceeds to box 374. In an instance in which the user input data 151 (FIG. 1) is not obtained, the process can return to box 362. Or, the process can proceed to completion.

In box 374, the module presentation application 124 (FIG. 1) stores the user input data 151 (FIG. 1) comprising the potential question. In box 377, the module presentation application 124 (FIG. 1) determines that an answer 133 (FIG. 1) to the potential question is available. In box 380, the module presentation application 124 (FIG. 1) generates a notification for notifying a student user that the answer 133 (FIG. 1) is available. Thereafter, the process proceeds to completion.

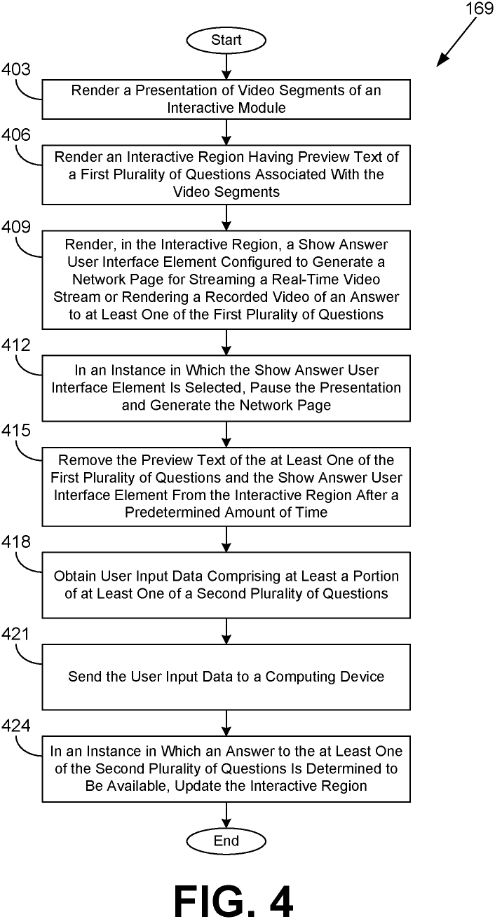

Referring next to FIG. 4, shown is a flowchart that provides one example of the operation of a portion of the application 169 (FIG. 1) according to various embodiments. Portions of the flowchart of FIG. 4 can be performed by the application 169 (FIG. 1) in communication with the module presentation application 124 (FIG. 1). It is understood that the flowchart of FIG. 4 provides merely an example of the many different types of functional arrangements that can be employed to implement the operation of the portion of the application 169 as described herein. As an alternative, the flowchart of FIG. 4 can be viewed as depicting an example of elements of a method implemented by a student user interface 200 (FIG. 2A) in the student client device 106b (FIG. 1) according to one or more embodiments.

Beginning with box 403, the application 169 (FIG. 1) renders a presentation of segments 145 (FIG. 1) of an interactive module 127 (FIG. 1). The segments 145 (FIG. 1) can include a plurality of video segments. In box 406, the application 169 (FIG. 1) renders an interactive region 209 (FIG. 2A) having a preview text 212a (FIG. 2A) of a first plurality of questions 130 (FIG. 1) associated with the segments 145.

In box 409, the application 169 (FIG. 1) renders, in the interactive region 209 (FIG. 2A), a show answer user interface element 213 (FIG. 2A) configured to generate a network page for streaming a real-time video stream or rendering a recorded video of an answer 133 (FIG. 1) to at least one of the first plurality of questions 130 (FIG. 1).

In box 412, the application 169 (FIG. 1) pauses, in an instance in which the show answer user interface element 213 (FIG. 2A) is selected, the presentation of the segments 145 (FIG. 1) and generates the network page that streams the real-time video stream or renders the recorded video of the answer 133 (FIG. 1). In box 415, the application 169 (FIG. 1) removes the preview text 212a (FIG. 2A) of the at least one of the first plurality of questions 130 (FIG. 1) and the show answer user interface element 213 (FIG. 2A) from the interactive region 209 IFIG. 2A) after a predetermined amount of time.

In box 418, the application 169 (FIG. 1) obtains user input data 151 (FIG. 1) comprising at least a portion of at least one of a second plurality of questions 130 (FIG. 1). In box 421, the application 169 (FIG. 1) sends the user input data 151 (FIG. 1) to a computing device of the computing environment 103 (FIG. 1). In box 424, the application 169 (FIG. 1) updates the interactive region 209 (FIG. 2A) in an instance in which an answer 133 (FIG. 1) to the at least one of the second plurality of questions 130 (FIG. 1) is determined to be available. Thereafter, the process proceeds to completion.

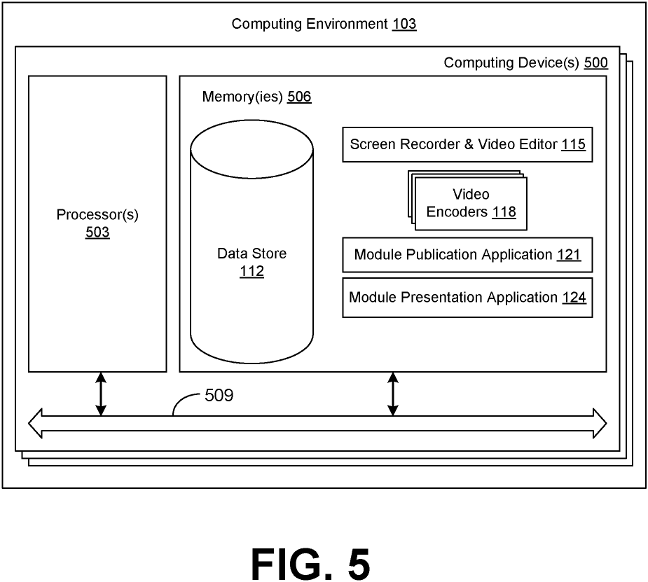

With reference to FIG. 5, shown is a schematic block diagram of the computing environment 103 according to an embodiment of the present disclosure. The computing environment 103 includes one or more computing devices 500. Each computing device 500 includes at least one processor circuit, for example, having a processor 503 and a memory 506, both of which are coupled to a local interface 509. To this end, each computing device 500 can comprise, for example, at least one server computer or like device. The local interface 509 can comprise, for example, a data bus with an accompanying address/control bus or other bus structure as can be appreciated.

Stored in the memory 506 are both data and several components that are executable by the processor 503. In particular, stored in the memory 506 and executable by the processor 503 are the screen recorder and video editor 115, the plurality of video encoders 118, the module publication application 121, the module presentation application 124, and potentially other applications. Also stored in the memory 506 can be a data store 112 and other data. In addition, an operating system can be stored in the memory 506 and executable by the processor 503.

It is understood that there may be other applications that are stored in the memory 506 and are executable by the processor 503 as can be appreciated. Where any component discussed herein is implemented in the form of software, any one of a number of programming languages may be employed such as, for example, C, C++, C#, Objective C, Java^{®}, JavaScript^{®}, Perl, PHP, Visual Basic^{®}, Python^{®}, Ruby, Flash^{®}, or other programming languages.

A number of software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may comprise additional systems designed to coordinate this communication, including, for example, performing load balancing. The processor 503 may be of electrical or of some other available construction.

Although the screen recorder and video editor 115, the plurality of video encoders 118, the module publication application 121, the module presentation application 124, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3A, 3B, and 4 show the functionality and operation of an implementation of portions of the operations of the networked environment 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts of FIGS. 3A, 3B, and 4 show a specific order of execution, it is understood that the order of execution may differ from that which is depicted. For example, the order of execution of two or more blocks may be scrambled relative to the order shown. Also, two or more blocks shown in succession in FIGS. 3A, 3B, and 4 may be executed concurrently or with partial concurrence. Further, in some embodiments, one or more of the blocks shown in FIGS. 3A, 3B, and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the screen recorder and video editor 115, the plurality of video encoders 118, the module publication application 121, or the module presentation application 124, that comprises software or code can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein including the screen recorder and video editor 115, the plurality of video encoders 118, the module publication application 121, or the module presentation application 124, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 500, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Embodiments of the present disclosure can be described in view of the following clauses:

Clause 1. A method, comprising: obtaining, by at least one computing device, an interactive module comprising a plurality of video segments and segment metadata associated with the plurality of video segments; obtaining, by the at least one computing device, a first plurality of questions associated with the interactive module, the first plurality of questions being stored in a data store; and generating, by the at least one computing device, a student user interface comprising a timeline, a presentation region for a presentation of the plurality of video segments on a display of a client device, an interactive region for a user of the client device to interact with questions and answers in association with the timeline, and a selectable user interface element configured to obtain, from the client device, user input data comprising at least a portion of at least one of a second plurality of questions.

Clause 2. The method according to clause 1, wherein the student user interface is configured to render, in the interactive region, a preview text of at least one of the first plurality of questions for a predetermined amount of time after the presentation reaches a timecode specified in the at least one of the first plurality of questions.

Clause 3. The method according to clause 1 or clause 2, further comprising: generating, by the at least one computing device, the at least one of the second plurality of questions based at least in part on processing the user input data.

Clause 4. The method according to any of clauses 1-3, further comprising: in an instance in which the user input data is obtained, determining an availability of an instructor user to answer the at least one of the second plurality of questions.

Clause 5. The method according to any of clauses 1-4, further comprising: in an instance in which it is determined that the instructor user is unavailable, generating, by the at least one computing device, a notification comprising a submission element configured to capture, from an instructor client device, answer data comprising a recorded video associated with the second plurality of questions.

Clause 6. The method according to any of clauses 1-5, further comprising: in an instance in which it is determined that the instructor user is available, generating, by the at least one computing device, an instructor user interface for presenting the at least one of the second plurality of questions to the instructor user, the instructor user interface configured to capture answer data comprising a real-time video stream associated with the second plurality of questions.

Clause 7. The method according to any of clauses 1-6, wherein the instructor user interface is configured to render an indication of a point during the presentation of the plurality of video segments that the user input data was obtained from the client device.

Clause 8. The method according to any of clauses 1-7, further comprising: publishing, by the at least one computing device, a preview text associated with the at least one of the second plurality of questions; and publishing, by the at least one computing device, the answer data for the interactive module based at least in part by storing, in the data store, an association of the answer data and the segment metadata.

Clause 9. The method according to any of clauses 1-8, wherein the student user interface is further configured to render, in the interactive region, the preview text, and a show answer user interface element configured to pause the presentation of the plurality of video segments, and generate a network page for streaming the real-time video stream.

Clause 10. A system, comprising: at least one processor; and a non-transitory computer-readable medium in communication with the at least one processor, wherein the at least one processor is configured to execute instructions embodied in the computer-readable medium to perform operations comprising: generating an instructor user interface configured to capture a video of a lecture; obtaining the video of the lecture; generating, based at least in part on the video, an interactive module including a plurality of segments and segment metadata; determining that an identifier of at least one of a chat request or a potential question is in a queue; and obtaining answer data comprising a video stream or a recorded video associated with the at least one of the chat request or the potential question.

Clause 11. The system according to clause 10, wherein the instructor user interface is further configured to render an indication of when the at least one of the chat request or the potential question occurred with respect to at least one of the plurality of segments.

Clause 12. The system according to clause 10 or clause 11, wherein the instructor user interface is further configured to render a presentation of at least one of the plurality of segments to provide context for the at least one of the chat request or the potential question.

Clause 13. The system according to any of clauses 10-12, wherein generating, based at least in part on the video, the interactive module including the plurality of segments and segment metadata comprises: tagging a question or an answer in the video based at least in part on at least one of: performing speech recognition to identify a keyword or phrase for a start of the question or the answer in the video, or the instructor user interface being further configured to indicate the start of the question or the answer in the video.

Clause 14. The system according to any of clauses 10-13, wherein the at least one processor is configured to execute instructions embodied in the computer-readable medium to perform operations comprising: publishing the answer data as an answer for at least one of the plurality of segments; and associating the answer with the at least one of the plurality of segments, at least one of a plurality of questions, and the segment metadata.

Clause 15. The system according to any of clauses 10-14, wherein the at least one processor is configured to execute instructions embodied in the computer-readable medium to perform operations comprising: modifying a timecode associated with the at least one of the plurality of questions.

Clause 16. The system according to any of clauses 10-15, wherein the at least one processor is configured to execute instructions embodied in the computer-readable medium to perform operations comprising: tagging the at least one of the plurality of questions with at least one of a difficulty or a topic.

Clause 17. A method, comprising: rendering, by at least one computing device, a presentation of a plurality of video segments of an interactive module; rendering, by at least one computing device, an interactive region comprising a preview text of at least one of a first plurality of questions associated with at least one of the plurality of video segments; rendering, in the interactive region, a show answer user interface element configured to generate a network page for streaming a real-time video stream or rendering a recorded video of an answer to the at least one of the first plurality of questions; and in an instance in which the show answer user interface element is selected, pausing, by the at least one computing device, the presentation of the plurality of video segments and generating the network page for streaming the real-time video stream or rendering the recorded video of the answer.

Clause 18. The method according to clause 17, further comprising: removing, by the at least one computing device, the preview text and the show answer user interface element from the interactive region after a predetermined amount of time; in an instance in which input data is obtained from an input field, sending, by the at least one computing device, the input data to a second computing device, the input data comprising at least a portion of at least one of a second plurality of questions; and in an instance in which an answer to the at least one of the second plurality of questions is determined to be available, updating, by the at least one computing device, the interactive region.

Clause 19. The method according to clause 17 or clause 18, wherein rendering the preview text and rendering the show answer user interface element is associated with a current timecode of the presentation, and the predetermined amount of time elapses based at least in part on the current timecode.

Clause 20. The method according to any of clauses 17-19, wherein the answer to the at least one of the second plurality of questions comprises an explanatory video comprising a screen recording, and updating the interactive region comprises generating a network page configured to render the explanatory video comprising the screen recording.

Clause 21. The method according to any of clauses 17-20, further comprising: obtaining, by the at least one computing device, a request to initiate a video chat with an instructor user associated with the answer to the at least one of the second plurality of questions.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore the following is claimed:

1. A method, comprising:
obtaining, by at least one computing device, an interactive module comprising a plurality of video segments and segment metadata associated with the plurality of video segments;
obtaining, by the at least one computing device, a first plurality of questions associated with the interactive module, the first plurality of questions being stored in a data store; and
generating, by the at least one computing device, a student user interface comprising a timeline, a presentation region for a presentation of the plurality of video segments on a display of a client device, an interactive region for a user of the client device to interact with questions and answers in association with the timeline, and a selectable user interface element configured to obtain, from the client device, user input data comprising at least a portion of at least one of a second plurality of questions.

2. The method of claim 1, wherein the student user interface is configured to render, in the interactive region, a preview text of at least one of the first plurality of questions for a predetermined amount of time after the presentation reaches a timecode specified in the at least one of the first plurality of questions.

3. The method of claim 1, further comprising:
generating, by the at least one computing device, the at least one of the second plurality of questions based at least in part on processing the user input data.

4. The method of claim 1, further comprising:
in an instance in which the user input data is obtained, determining an availability of an instructor user to answer the at least one of the second plurality of questions.

5. The method of claim 4, further comprising:
in an instance in which it is determined that the instructor user is unavailable, generating, by the at least one computing device, a notification comprising a submission element configured to capture, from an instructor client device, answer data comprising a recorded video associated with the second plurality of questions.

6. The method of claim 4, further comprising:
in an instance in which it is determined that the instructor user is available, generating, by the at least one computing device, an instructor user interface for presenting the at least one of the second plurality of questions to the instructor user, the instructor user interface configured to capture answer data comprising a real-time video stream associated with the second plurality of questions.

7. The method of claim 6, wherein the instructor user interface is configured to render an indication of a point during the presentation of the plurality of video segments that the user input data was obtained from the client device.

8. The method of claim 6, further comprising:
publishing, by the at least one computing device, a preview text associated with the at least one of the second plurality of questions; and
publishing, by the at least one computing device, the answer data for the interactive module based at least in part by storing, in the data store, an association of the answer data and the segment metadata.

9. The method of claim 8, wherein the student user interface is further configured to render, in the interactive region, the preview text, and a show answer user interface element configured to pause the presentation of the plurality of video segments, and generate a network page for streaming the real-time video stream.

10. A system, comprising:
at least one processor; and
a non-transitory computer-readable medium in communication with the at least one processor, wherein the at least one processor is configured to execute instructions embodied in the computer-readable medium to perform operations comprising:
generating an instructor user interface configured to capture a video of a lecture;
obtaining the video of the lecture;
generating, based at least in part on the video, an interactive module including a plurality of segments and segment metadata;
determining that an identifier of at least one of a chat request or a potential question is in a queue; and
obtaining answer data comprising a video stream or a recorded video associated with the at least one of the chat request or the potential question.

11. The system of claim 10, wherein the instructor user interface is further configured to render an indication of when the at least one of the chat request or the potential question occurred with respect to at least one of the plurality of segments.

12. The system of claim 10, wherein the instructor user interface is further configured to render a presentation of at least one of the plurality of segments to provide context for the at least one of the chat request or the potential question.

13. The system of claim 10, wherein generating, based at least in part on the video, the interactive module including the plurality of segments and segment metadata comprises:
tagging a question or an answer in the video based at least in part on at least one of: performing speech recognition to identify a keyword or phrase for a start of the question or the answer in the video, or the instructor user interface being further configured to indicate the start of the question or the answer in the video.

14. The system of claim 10, wherein the at least one processor is configured to execute instructions embodied in the computer-readable medium to perform operations comprising:
publishing the answer data as an answer for at least one of the plurality of segments; and
associating the answer with the at least one of the plurality of segments, at least one of a plurality of questions, and the segment metadata.

15. The system of claim 14, wherein the at least one processor is configured to execute instructions embodied in the computer-readable medium to perform operations comprising:
modifying a timecode associated with the at least one of the plurality of questions.

16. The system of claim 14, wherein the at least one processor is configured to execute instructions embodied in the computer-readable medium to perform operations comprising:
tagging the at least one of the plurality of questions with at least one of a difficulty or a topic.

17. A method, comprising:
rendering, by at least one computing device, a presentation of a plurality of video segments of an interactive module;
rendering, by at least one computing device, an interactive region comprising a preview text of at least one of a first plurality of questions associated with at least one of the plurality of video segments;
rendering, in the interactive region, a show answer user interface element configured to generate a network page for streaming a real-time video stream or rendering a recorded video of an answer to the at least one of the first plurality of questions; and
in an instance in which the show answer user interface element is selected, pausing, by the at least one computing device, the presentation of the plurality of video segments and generating the network page for streaming the real-time video stream or rendering the recorded video of the answer.

18. The method of claim 17, further comprising:
removing, by the at least one computing device, the preview text and the show answer user interface element from the interactive region after a predetermined amount of time;
in an instance in which input data is obtained from an input field, sending, by the at least one computing device, the input data to a second computing device, the input data comprising at least a portion of at least one of a second plurality of questions; and
in an instance in which an answer to the at least one of the second plurality of questions is determined to be available, updating, by the at least one computing device, the interactive region.

19. The method of claim 18, wherein rendering the preview text and rendering the show answer user interface element is associated with a current timecode of the presentation, and the predetermined amount of time elapses based at least in part on the current timecode.

20. The method of claim 18, wherein the answer to the at least one of the second plurality of questions comprises an explanatory video comprising a screen recording, and updating the interactive region comprises generating a network page configured to render the explanatory video comprising the screen recording.

21. The method of claim 18, further comprising:
obtaining, by the at least one computing device, a request to initiate a video chat with an instructor user associated with the answer to the at least one of the second plurality of questions.
